(19) United States
(12) Patent Application Publication
(10) Pub. No.: US 2025/0356198 A1
(43) Pub. Date: Nov. 20, 2025

(54) METHOD AND SYSTEM FOR DETECTION AND MITIGATION OF ARTIFICIAL INTELLIGENCE HALLUCINATIONS

(71) Applicant: JPMorgan Chase Bank, N.A., New York, NY (US)

(72) Inventors: Vineeth RAVI, Jersey City, NJ (US); Kelly PATEL, Hopewell Junction, NY (US); Simran LAMBA, Manhattan, NY (US); Mirazul HAQUE, Secaucus, NJ (US); Jessica STADDON, Redwood City, CA (US)

(73) Assignee: JPMorgan Chase Bank, N.A., New York, NY (US)

(21) Appl. No.: 18/666,370

(22) Filed: May 16, 2024

(51) Int. Cl. G06N 3/0895

(52) U.S. Cl. CPC G06N 3/0895

(57) ABSTRACT

Methods and systems for detecting and mitigating hallucinations in artificial intelligence (AI) summarizations of user-generated content are provided. The method includes: receiving an AI-generated content item; retrieving historical content items that have been generated by human beings; comparing the AI-generated content item with the historical content items in order to determine whether text string matches are present; when a determination is made that no match exists, performing a semantic matching operation to identify text strings included in the historical content items that are semantically similar to text strings in the AI-generated content item; and determining, based on the comparison and the semantic matching operation, whether the AI-generated content item is a hallucination. When a hallucination is detected, the hallucination may be mitigated by removing a textual perturbation and/or replacing the textual perturbation with text that accurately reflects the original content item.

### BACKGROUND

### 1. Field of the Disclosure

This technology relates to methods and systems for detecting and mitigating hallucinations in artificial intelligence (AI) summarizations of user-generated content.

### 2. Background Information

Large language models (LLMs) have gained widespread adoption over the past few years as a tool that is usable for many tasks, including tasks that relate to generating various types of written content. For example, an LLM may be used to compose content that is intended to emulate a writing style of an author, poet, or writer for whom a sufficient volume of previous writings are available for training the LLM. However, one potential drawback of using an LLM to generate content is the possibility that the LLM may generate a hallucination, i.e., a response to an input prompt that is factually incorrect, nonsensical, and/or disconnected from the input prompt.

Zagat is a well-known source of trusted restaurant reviews. It most recently published in 2019-2020 with manually written reviews. In light of the emergence of LLMs for generating written content, it may be possible to leverage artificial intelligence (AI) for AI-driven review generation to allow publishing with broad restaurant coverage. Through constrained prompting, reviews may be generated to emulate the classic Zagat style, which incorporates customer survey responses to present opinions of diners to the public. However, with AI-generated content, it is crucial that such reviews be properly representative of customer comments, and that no hallucinated content be generated.

Accordingly, there is a need for a mechanism for detecting and mitigating hallucinations in AI summarizations of user-generated content.

### SUMMARY

The present disclosure, through one or more of its various aspects, embodiments, and/or specific features or sub-components, provides, inter alia, various systems, servers, devices, methods, media, programs, and platforms for methods and systems for detecting and mitigating hallucinations in AI summarizations of user-generated content.

According to an aspect of the present disclosure, a method for detecting and mitigating an AI-generated hallucination is provided. The method is implemented by at least one processor. The method includes: receiving, by the at least one processor, a first AI-generated content item that has been generated by a large language model (LLM); retrieving, by the at least one processor, a plurality of historical content items that have been generated by human beings; comparing, by the at least one processor, the first AI-generated content item with the plurality of historical content items in order to determine whether a first text string included within the first AI-generated content item matches with a text string included in at least one from among the plurality of historical content items; when a determination is made that no match exists, performing a semantic matching operation to identify at least one text string included in the plurality of historical content items that is semantically similar to the first text string; and determining, based on a result of the comparing and a result of the performing of the semantic matching operation, whether the first AI-generated content item is a hallucination.

The method may further include using a result of the semantic matching operation to generate a semantic similarity score with respect to each of the plurality of historical content items by using cosine similarity and pre-trained robustly optimized Bidirectional Encoder Representations from Transformers approach (roBERTa) embeddings.

The first AI-generated content item may include a textual perturbation of a first historical content item from among the plurality of historical content items.

The determining of whether the first AI-generated content item is a hallucination may include using a first chain of summarization verification (CSV) technique to detect the hallucination by: prompting the LLM to generate at least one question that relates to determining whether each line of the first AI-generated content item accurately reflects the first historical content item; and prompting the LLM to generate a respective response to each of the at least one question by comparing the first AI-generated content item with the first historical content item.

When the hallucination is detected, the method may further include using a second CSV technique to mitigate the hallucination by performing one from among removing the textual perturbation; replacing the textual perturbation with first text that accurately reflects the first historical content item; replacing the textual perturbation with second text that does not accurately reflect the first historical content item; and making no modification to the textual perturbation.

The method may further include obtaining at least one from among a first metric that relates to successfully removing the textual perturbation, a second metric that relates to accurately replacing the textual perturbation, a third metric that relates to inaccurately replacing the textual perturbation, and a fourth metric that relates to failing to modify the textual perturbation.

The plurality of historical content items may include at least ten (10) historical content items.

The method may further include generating a first spreadsheet that classifies each of a plurality of text strings from within the first AI-generated content items as corresponding to one from among a highly modified quote, a moderately modified quote, a lowly modified quote, and a valid quote. The first spreadsheet may include a repetition summary that relates to repetitive word usage in the first AI-generated content item.

The method may further include generating a second spreadsheet that includes a similarity score of the first AI-generated content item with respect to each of the plurality of historical content items, an edit level of the first AI-generated content item that includes one from among a low edit level, a medium edit level, and a high edit level, and a similarity ranking of the first AI-generated content item with respect to each of the plurality of historical content items.

According to yet another exemplary embodiment, a computing apparatus for detecting and mitigating an AI-generated hallucination is provided. The computing apparatus includes a processor; a memory; and a communication interface coupled to each of the processor and the memory. The processor is configured to: receive, via the communication interface, a first AI-generated content item that has been generated by a large language model (LLM); retrieve, from the memory, a plurality of historical content items that have been generated by human beings; compare the first AI-generated content item with the plurality of historical content items in order to determine whether a first text string included within the first AI-generated content item matches with a text string included in at least one from among the plurality of historical content items; when a determination is made that no match exists, perform a semantic matching operation to identify at least one text string included in the plurality of historical content items that is semantically similar to the first text string; and determine, based on a result of the comparison and a result of the performance of the semantic matching operation, whether the first AI-generated content item is a hallucination.

The processor may be further configured to use a result of the semantic matching operation to generate a semantic similarity score with respect to each of the plurality of historical content items by using cosine similarity and pre-trained roBERTa embeddings.

The first AI-generated content item may include a textual perturbation of a first historical content item from among the plurality of historical content items.

The processor may be further configured to determine whether the first AI-generated content item is a hallucination by using a first chain of summarization verification (CSV) technique to detect the hallucination by: prompting the LLM to generate at least one question that relates to determining whether each line of the first AI-generated content item accurately reflects the first historical content item; and prompting the LLM to generate a respective response to each of the at least one question by comparing the first AI-generated content item with the first historical content item.

Wherein when the hallucination is detected, the processor may be further configured to use a second CSV technique to mitigate the hallucination by performing one from among removing the textual perturbation; replacing the textual perturbation with first text that accurately reflects the first historical content item; replacing the textual perturbation with second text that does not accurately reflect the first historical content item; and making no modification to the textual perturbation.

The processor may be further configured to obtain at least one from among a first metric that relates to successfully removing the textual perturbation, a second metric that relates to accurately replacing the textual perturbation, a third metric that relates to inaccurately replacing the textual perturbation, and a fourth metric that relates to failing to modify the textual perturbation.

The plurality of historical content items may include at least ten (10) historical content items.

The processor may be further configured to generate a first spreadsheet that classifies each of a plurality of text strings from within the first AI-generated content items as corresponding to one from among a highly modified quote, a moderately modified quote, a lowly modified quote, and a valid quote. The first spreadsheet may include a repetition summary that relates to repetitive word usage in the first AI-generated content item.

The processor may be further configured to generate a second spreadsheet that includes a similarity score of the first AI-generated content item with respect to each of the plurality of historical content items, an edit level of the first AI-generated content item that includes one from among a low edit level, a medium edit level, and a high edit level, and a similarity ranking of the first AI-generated content item with respect to each of the plurality of historical content items.

According to yet another exemplary embodiment, a non-transitory computer readable storage medium storing instructions for detecting and mitigating an AI-generated hallucination is provided. The storage medium includes executable code which, when executed by a processor, causes the processor to: receive a first AI-generated content item that has been generated by a large language model (LLM); retrieve a plurality of historical content items that have been generated by human beings; compare the first AI-generated content item with the plurality of historical content items in order to determine whether a first text string included within the first AI-generated content item matches with a text string included in at least one from among the plurality of historical content items; when a determination is made that no match exists, perform a semantic matching operation to identify at least one text string included in the plurality of historical content items that is semantically similar to the first text string; and determine, based on a result of the comparison and a result of the performance of the semantic matching operation, whether the first AI-generated content item is a hallucination.

When executed by the processor, the executable code may be further configured to cause the processor to use a result of the semantic matching operation to generate a semantic similarity score with respect to each of the plurality of historical content items by using cosine similarity and pre-trained robustly roBERTa embeddings.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for detecting and mitigating hallucinations in AI summarizations of user-generated content.

FIG. 4 is a flowchart of an exemplary process for implementing a method for detecting and mitigating hallucinations in AI summarizations of user-generated content.

FIG. 5 is an illustration of an example of a first type of spreadsheet that is generated as a result of executing a method for detecting and mitigating hallucinations in AI summarizations of user-generated content, according to an exemplary embodiment.

FIG. 6 is an illustration of an example of a second type of spreadsheet that is generated as a result of executing a method for detecting and mitigating hallucinations in AI summarizations of user-generated content, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

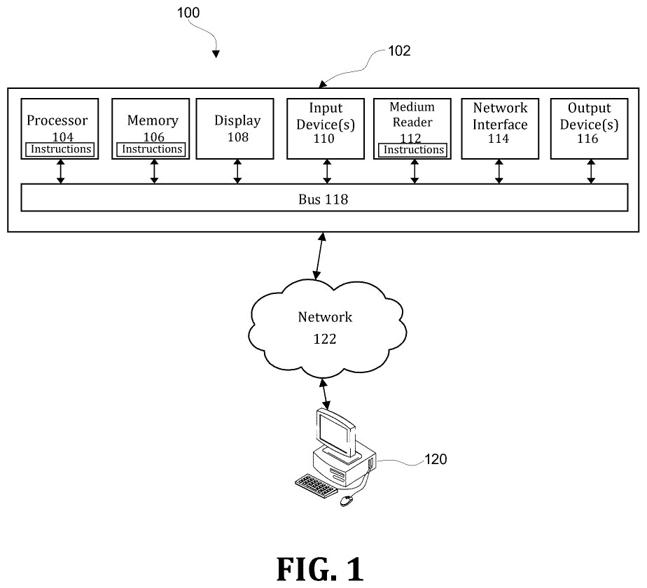

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for detecting and mitigating hallucinations in AI summarizations of user-generated content.

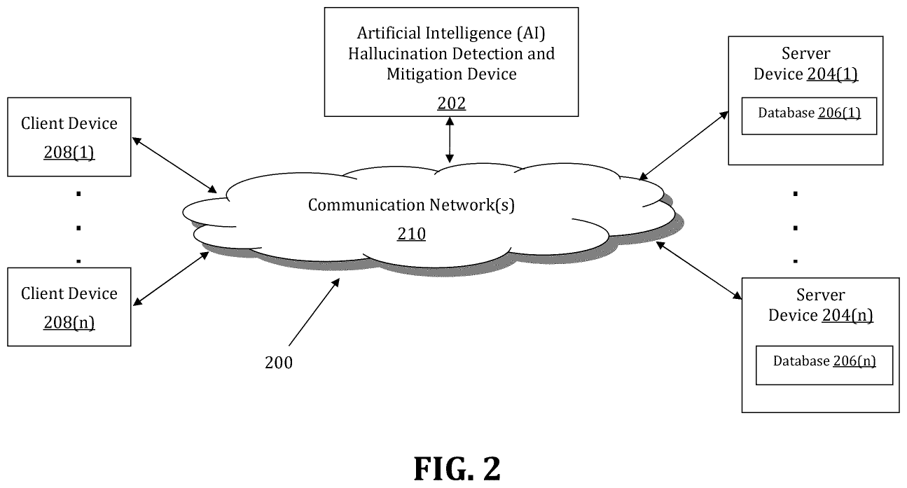

Referring to FIG. 2, a schematic of an exemplary network environment 200 for implementing a method for detecting and mitigating hallucinations in AI summarizations of user-generated content is illustrated. In an exemplary embodiment, the method is executable on any networked computer platform, such as, for example, a personal computer (PC).

The method for mitigating hallucinations in AI summarizations of user-generated content may be implemented by an Artificial Intelligence Hallucination Detection and Mitigation (AIHDM) device 202. The AIHDM device 202 may be the same or similar to the computer system 102 as described with respect to FIG. 1. The AIHDM device 202 may store one or more applications that can include executable instructions that, when executed by the AIHDM device 202, cause the AIHDM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AIHDM device 202 itself, may be located in virtual server(s) running in a cloud-based computing environment rather than being tied to one or more specific physical network computing devices. Also, the application(s) may be running in one or more virtual machines (VMs) executing on the AIHDM device 202. Additionally, in one or more embodiments of this technology, virtual machine(s) running on the AIHDM device 202 may be managed or supervised by a hypervisor.

In the network environment 200 of FIG. 2, the AIHDM device 202 is coupled to a plurality of server devices 204(1)-204(n) that hosts a plurality of databases 206(1)-206(n), and also to a plurality of client devices 208(1)-208(n) via communication network(s) 210. A communication interface of the AIHDM device 202, such as the network interface 114 of the computer system 102 of FIG. 1, operatively couples and communicates between the AIHDM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AIHDM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AIHDM devices that efficiently implement a method for detecting and mitigating hallucinations in AI summarizations of user-generated content.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AIHDM device 202 may be a standalone device or integrated with one or more other devices or apparatuses, such as one or more of the server devices 204(1)-204(n), for example. In one particular example, the AIHDM device 202 may include or be hosted by one of the server devices 204(1)-204(n), and other arrangements are also possible. Moreover, one or more of the devices of the AIHDM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AIHDM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to historical content that is usable for training a model and information that relates to metrics for detecting and mitigating hallucinations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AIHDM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AIHDM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AIHDM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AIHDM device 202, the server devices 204(1)-204(n), or the client devices 208(1)-208(n), for example, may be configured to operate as virtual instances on the same physical machine. In other words, one or more of the AIHDM device 202, the server devices 204(1)-204(n), or the client devices 208(1)-208(n) may operate on the same physical device rather than as separate devices communicating through communication network(s) 210. Additionally, there may be more or fewer AIHDM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

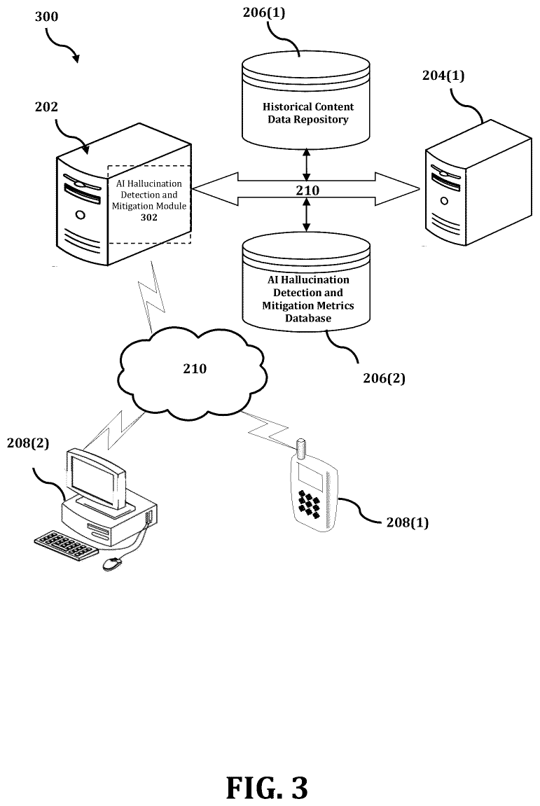

The AIHDM device 202 is described and illustrated in FIG. 3 as including an AI hallucination detection and mitigation module 302, although it may include other rules, policies, modules, databases, or applications, for example. As will be described below, the AI hallucination detection and mitigation module 302 is configured to implement a method for detecting and mitigating hallucinations in AI summarizations of user-generated content.

An exemplary process 300 for implementing a mechanism for mitigating hallucinations in AI summarizations of user-generated content by utilizing the network environment of FIG. 2 is illustrated as being executed in FIG. 3. Specifically, a first client device 208(1) and a second client device 208(2) are illustrated as being in communication with AIHDM device 202. In this regard, the first client device 208(1) and the second client device 208(2) may be “clients” of the AIHDM device 202 and are described herein as such. Nevertheless, it is to be known and understood that the first client device 208(1) and/or the second client device 208(2) need not necessarily be “clients” of the AIHDM device 202, or any entity described in association therewith herein. Any additional or alternative relationship may exist between either or both of the first client device 208(1) and the second client device 208(2) and the AIHDM device 202, or no relationship may exist.

Further, AIHDM device 202 is illustrated as being able to access a historical content data repository 206(1) and an AI hallucination detection and mitigation metrics database 206(2). The AI hallucination detection and mitigation module 302 may be configured to access these databases for implementing a method for detecting and mitigating hallucinations in AI summarizations of user-generated content.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the AIHDM device 202 via broadband or cellular communication. Of course, these embodiments are merely exemplary and are not limiting or exhaustive.

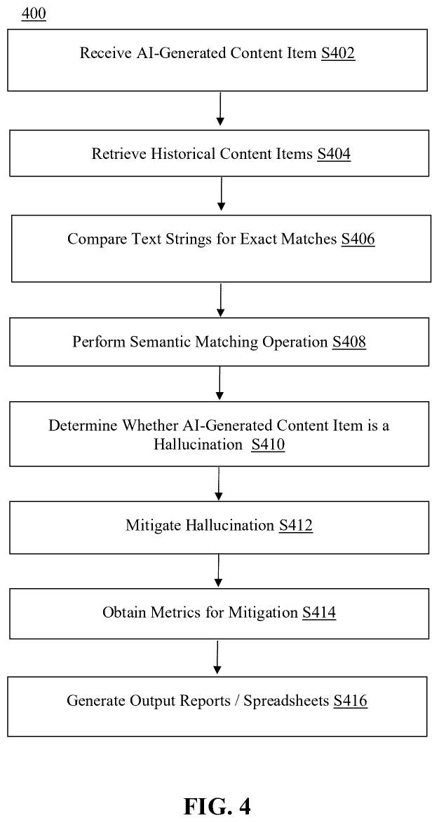

Upon being started, the AI hallucination detection and mitigation module 302 executes a process for detecting and mitigating hallucinations in AI summarizations of user-generated content. An exemplary process for detecting and mitigating hallucinations in AI summarizations of user-generated content is generally indicated at flowchart 400 in FIG. 4.

In process 400 of FIG. 4, at step S402, the AI hallucination detection and mitigation module 302 receives a AI-generated content item. In an exemplary embodiment, the AI-generated content item is generated by a predetermined large language model (LLM), such as, for example, a GPT-2 model or a Llama-2 model that is trained for various types of tasks, such as generating restaurant reviews or movie reviews; generating news articles that relate to world events, sports, business, or science; generating social media posts that relate to bullish, bearish, or neutral market commentaries; generating social media posts that express positive, negative, or neutral sentiments; or generating social media posts that express anger, joy, optimism, or sadness emotions.

At step S404, the AI hallucination detection and mitigation module 302 retrieves a plurality of historical content items that have been created by human beings. In an exemplary embodiment, the plurality of historical content items may include at least ten (10) items in order to ensure a sufficiently large set for purposes of accuracy and robustness with respect to the hallucination detection and mitigation capabilities.

At step S406, the AI hallucination detection and mitigation module 302 compares the AI-generated content item with the plurality of historical content items in order to determine whether there are exact matches between text strings included within the AI-generated content item and text strings included in any of the historical content items. In an exemplary embodiment, the AI-generated content item may include one or more textual perturbations of the text included in a historical content item, and in this circumstance, there may be may exact matches for text strings that have not been perturbed.

At step S408, the AI hallucination detection and mitigation module 302 performs a semantic matching operation with respect to a text string included in the AI-generated content item for which no exact match is found in step S406. The purpose of the semantic matching operation is to identify one or more text strings from within the plurality of historical content items that is semantically similar to the unmatched text string. In an exemplary embodiment, the semantic matching operation may use a cosine similarity technique and a pre-trained robustly optimized Bidirectional Encoder Representations from Transformers approach (hereinafter referred to as “roBERTa”) to generate a similarity score between the text string included in the AI-generated content item and a particular text string included in the historical content items.

At step S410, the AI hallucination detection and mitigation module 302 uses a result of the comparisons in step S406 and a result of the semantic matching operation in step S408 to determine whether the AI-generated content item is a hallucination. In an exemplary embodiment, the determination as to whether the AI-generated content item is a hallucination may be implemented by using a first chain of summarization verification (CSV) technique to detect a hallucination. This CSV technique may firstly include prompting the LLM to generate one or more questions that are designed to determine whether each line of the text of the AI-generated content item accurately reflects the particular historical content item for which a relatively high level of similarity has been observed. Then, a second prompting of the LLM may be provided in order to generate respective responses to the questions by comparing the AI-generated content item with the particular historical content item on a line-by-line basis.

At step S412, when a determination has been made in step S410 that the AI-generated content item is a hallucination, the AI hallucination detection and mitigation module 302 mitigates the hallucination. In an exemplary embodiment, the mitigation of the hallucination may be implemented by using a second CSV technique by which textual perturbations are either removed or replaced with other text that is intended to accurately reflect the original intent. In this aspect, the second CSV technique may entail the performance of any of the following four operations: 1) successful removal of an inaccurate textual perturbation; 2) replacement of the textual perturbation with text that accurately reflects the particular historical content item; 3) replacement of the textual perturbation with text that does not accurately reflect the original; and 4) no modification, i.e., a failure to replace or remove the textual perturbation.

At step S414, the AI hallucination detection and mitigation module 302 obtains metrics for the mitigation performed in step S412. In an exemplary embodiment, the metrics may include any one or more of a first metric that relates to successfully removing the textual perturbation; a second metric that relates to accurately replacing the textual perturbation; a third metric that relates to inaccurately replacing the textual perturbation; and a fourth metric that relates to failing to modify the textual perturbation. Each metric may be expressed as a percentage or ratio between the aspect being measured and the maximum number of opportunities to perform the aspect being measured. For example, re the first metric, supposing that the AI-generated content item has 20 textual perturbations that would be good candidates for removal and 17 have been successfully removed as a result of the mitigation performed in step S412, then the first metric is equal to 17/20=85%.

At step S416, the AI hallucination detection and mitigation module 302 generates one or more output reports and/or spreadsheets that provide information that assists a user with understanding the results of the detection and mitigation operations. In an exemplary embodiment, a first spreadsheet may classify various text strings that are included in the AI-generated content item as corresponding to a highly modified quote, a moderately modified quote, a lowly modified quote, or a valid quote. The first spreadsheet may also include a repetition summary that relates to words that are used repetitively in the AI-generated content item. In an exemplary embodiment, a second spreadsheet may include a similarity score of the AI-generated content item with respect to a particular historical content item, an edit level of the AI-generated content item that may reflect a high edit level, a medium edit level, or a low edit level, and a similarity ranking that indicates which particular historical content item is most similar to the AI-generated content item.

In an exemplary embodiment, to assist with detection of hallucinations in AI-generated content, an additional dataset may be generated by perturbing LLM-generated content in a manner that intentionally emulates naturally occurring hallucinations. In one use case, the additional dataset includes thousands of LLM-generated restaurant reviews for over 1000 restaurants in New York City, and for each review, there is at least one perturbation that represents either hallucinated content or non-hallucinated content. The additional dataset is then usable for training a binary classifier, for example, by taking a context window of text around the perturbed text span and tasking the classifier to use contextual clues to determine whether or the perturbation represents hallucinated content. The results obtained from the binary classifier may then be combined with the results obtained from using the CSV techniques described above to improve overall accuracy and mitigate inconsistencies.

In an exemplary embodiment, the present inventive concept may be applicable to a use case that relates to generating a Zagat-style restaurant review. The following is a description of this use case. The present inventive concept provides a tool that is designed to help facilitate the validation of AI-generated Zagat-style restaurant reviews to ensure verifiable, credible, and interesting reviews. Once a review is generated for a restaurant, this tool checks for hallucinations, quotes that do not reflect customer survey responses, and repetitiveness that leads to uninteresting and/or untrustworthy restaurant reviews. By making use of pre-trained LLM embedding schemes, the tool presents quantitative evaluations of the review content to human editors, who may choose to use the automated results to guide their manual validation before publishing reviews to customers.

For a single restaurant, the tool takes as input an AI-generated review, together with a spreadsheet containing customer survey responses for that restaurant. The customer survey responses are free-form comments, which may contain spelling and/or grammatical errors. In an exemplary embodiment, there are at least ten (10) customer responses used to generate a review, and no upper bound for responses per restaurant, with a character limit of 600 characters per response.

Methodology: In an exemplary embodiment, the tool may check quoted verbatims within the review to ensure they are valid and viable by using a two-step validation process. First, the tool may check for exact quote matches, i.e., string matching, among customer reviews. In the cases where an exact match is not found, the tool may then proceed to the second step, which entails a semantic checking operation using pre-trained roBERTa embeddings and cosine similarity to find the most similar customer reviews with associated similarity scores, in order to help a human editor determine whether or not the quote can be used. In an exemplary embodiment, the tool may also check for repetitiveness with respect to adjectives and nouns that are used within the review.

In an exemplary embodiment, various AI and machine learning techniques may be used to embed quotes and customer survey responses to measure semantic similarity between them. To ensure validity, quotes should maintain the same semantic meaning as the source customer comment. Statistical measures like term frequency-inverse document frequency (TF-IDF), regexes, and fuzzy string matching are common approaches to string validation, but do not perform as well in finding similar customer survey responses. For example, if a customer survey response is “the food was very close to perfection” and the generated review contains the verbatim, “the food was near-perfect”, these two statements semantically share a meaning, but would have a low similarity score in fuzzy matching, which relies solely on edit distance.

The use of pre-trained encodings for string semantic comparison is an industry standard practice, with relatively low risk. In an exemplary embodiment, it has been determined through manual validation that ROBERTa provides a relatively accurate way to determine accuracy re semantic meaning.

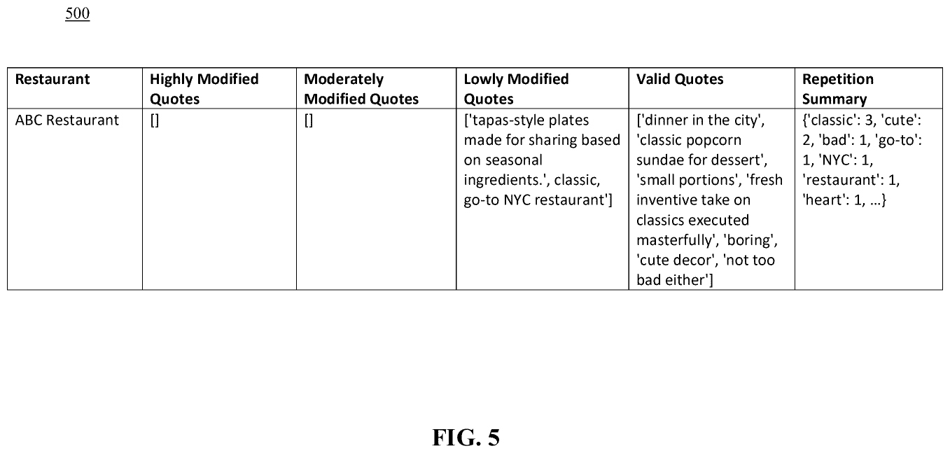

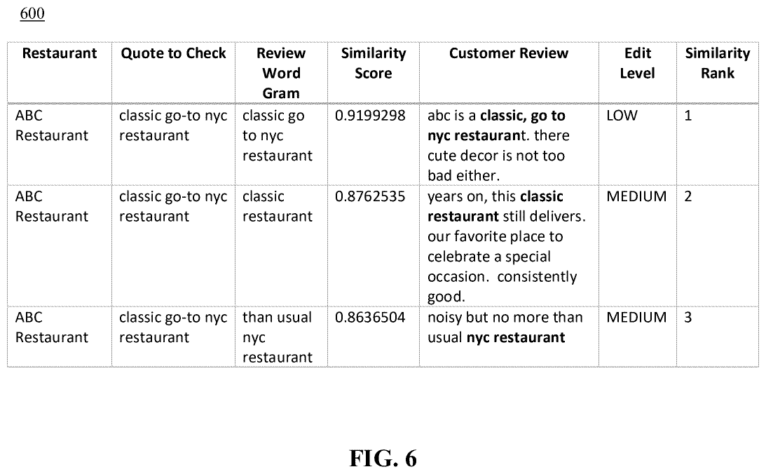

In an exemplary embodiment, the tool generates two types of reports with results from its analysis. FIG. 5 is an illustration 500 of an example of a first type of spreadsheet that is generated as a result of executing a method for detecting and mitigating hallucinations in AI summarizations of user-generated content, according to an exemplary embodiment. FIG. 6 is an illustration 600 of an example of a second type of spreadsheet that is generated as a result of executing a method for detecting and mitigating hallucinations in AI summarizations of user-generated content, according to an exemplary embodiment.

Referring to FIG. 5, the first report is a summative spreadsheet which breaks down all quoted verbatims within a review per restaurant and, based on the similarity score, classifies each quote as “Highly Modified”, i.e., having a similarity score that is less than 0.7; “Moderately Modified”, i.e., having a similarity score that is greater than or equal to 0.7 and less than 0.9; “Lowly Modified”, having a similarity score that is greater than or equal to 0.9 and less than 1, or “Valid”, i.e., having a similarity score that is equal to 1. Additionally, per restaurant, the first report highlights any nouns and/or adjectives that are used repetitively and the number of times they appear in the review.

Referring to FIG. 6, the second spreadsheet further breaks down the quotes, by providing the top three similar customer survey responses and their affiliated similarity scores. The second spreadsheet also assigns a label, i.e., “LOW”, “MEDIUM”, or “HIGH”, that corresponds to how much editing is applied to the analyzed quote.

Accordingly, with this technology, an optimized process for detecting and mitigating hallucinations in AI summarizations of user-generated content is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for detecting and mitigating an artificial intelligence (AI)-generated hallucination, the method being implemented by at least one processor, the method comprising:
receiving, by the at least one processor, a first AI-generated content item that has been generated by a large language model (LLM);
retrieving, by the at least one processor, a plurality of historical content items that have been generated by human beings;
comparing, by the at least one processor, the first AI-generated content item with the plurality of historical content items in order to determine whether a first text string included within the first AI-generated content item matches with a text string included in at least one from among the plurality of historical content items;
when a determination is made that no match exists, performing a semantic matching operation to identify at least one text string included in the plurality of historical content items that is semantically similar to the first text string; and
determining, based on a result of the comparing and a result of the performing of the semantic matching operation, whether the first AI-generated content item is a hallucination.

2. The method of claim 1, further comprising using a result of the semantic matching operation to generate a semantic similarity score with respect to each of the plurality of historical content items by using cosine similarity and pre-trained robustly optimized Bidirectional Encoder Representations from Transformers approach (roBERTa) embeddings.

3. The method of claim 1, wherein the first AI-generated content item includes a textual perturbation of a first historical content item from among the plurality of historical content items.

4. The method of claim 3, wherein the determining of whether the first AI-generated content item is a hallucination comprises using a first chain of summarization verification (CSV) technique to detect the hallucination by:
prompting the LLM to generate at least one question that relates to determining whether each line of the first AI-generated content item accurately reflects the first historical content item; and
prompting the LLM to generate a respective response to each of the at least one question by comparing the first AI-generated content item with the first historical content item.

5. The method of claim 4, wherein when the hallucination is detected, the method further comprises using a second CSV technique to mitigate the hallucination by performing one from among removing the textual perturbation; replacing the textual perturbation with first text that accurately reflects the first historical content item; replacing the textual perturbation with second text that does not accurately reflect the first historical content item; and making no modification to the textual perturbation.

6. The method of claim 5, further comprising obtaining at least one from among a first metric that relates to successfully removing the textual perturbation, a second metric that relates to accurately replacing the textual perturbation, a third metric that relates to inaccurately replacing the textual perturbation, and a fourth metric that relates to failing to modify the textual perturbation.

7. The method of claim 1, wherein the plurality of historical content items includes at least ten (10) historical content items.

8. The method of claim 1, further comprising generating a first spreadsheet that classifies each of a plurality of text strings from within the first AI-generated content items as corresponding to one from among a highly modified quote, a moderately modified quote, a lowly modified quote, and a valid quote,
wherein the first spreadsheet includes a repetition summary that relates to repetitive word usage in the first AI-generated content item.

9. The method of claim 8, further comprising generating a second spreadsheet that includes a similarity score of the first AI-generated content item with respect to each of the plurality of historical content items, an edit level of the first AI-generated content item that includes one from among a low edit level, a medium edit level, and a high edit level, and a similarity ranking of the first AI-generated content item with respect to each of the plurality of historical content items.

10. A computing apparatus for detecting and mitigating an artificial intelligence (AI)-generated hallucination, the computing apparatus comprising:
a processor;
a memory; and
a communication interface coupled to each of the processor and the memory,
wherein the processor is configured to:
receive, via the communication interface, a first AI-generated content item that has been generated by a large language model (LLM);
retrieve, from the memory, a plurality of historical content items that have been generated by human beings;
compare the first AI-generated content item with the plurality of historical content items in order to determine whether a first text string included within the first AI-generated content item matches with a text string included in at least one from among the plurality of historical content items;
when a determination is made that no match exists, perform a semantic matching operation to identify at least one text string included in the plurality of historical content items that is semantically similar to the first text string; and
determine, based on a result of the comparison and a result of the performance of the semantic matching operation, whether the first AI-generated content item is a hallucination.

11. The computing apparatus of claim 10, wherein the processor is further configured to use a result of the semantic matching operation to generate a semantic similarity score with respect to each of the plurality of historical content items by using cosine similarity and pre-trained robustly optimized Bidirectional Encoder Representations from Transformers approach (roBERTa) embeddings.

12. The computing apparatus of claim 10, wherein the first AI-generated content item includes a textual perturbation of a first historical content item from among the plurality of historical content items.

13. The computing apparatus of claim 12, wherein the processor is further configured to determine whether the first AI-generated content item is a hallucination by using a first chain of summarization verification (CSV) technique to detect the hallucination by:
prompting the LLM to generate at least one question that relates to determining whether each line of the first AI-generated content item accurately reflects the first historical content item; and
prompting the LLM to generate a respective response to each of the at least one question by comparing the first AI-generated content item with the first historical content item.

14. The computing apparatus of claim 13, wherein when the hallucination is detected, the processor is further configured to use a second CSV technique to mitigate the hallucination by performing one from among removing the textual perturbation; replacing the textual perturbation with first text that accurately reflects the first historical content item; replacing the textual perturbation with second text that does not accurately reflect the first historical content item; and making no modification to the textual perturbation.

15. The computing apparatus of claim 14, wherein the processor is further configured to obtain at least one from among a first metric that relates to successfully removing the textual perturbation, a second metric that relates to accurately replacing the textual perturbation, a third metric that relates to inaccurately replacing the textual perturbation, and a fourth metric that relates to failing to modify the textual perturbation.

16. The computing apparatus of claim 10, wherein the plurality of historical content items includes at least ten (10) historical content items.

17. The computing apparatus of claim 10, wherein the processor is further configured to generate a first spreadsheet that classifies each of a plurality of text strings from within the first AI-generated content items as corresponding to one from among a highly modified quote, a moderately modified quote, a lowly modified quote, and a valid quote,
wherein the first spreadsheet includes a repetition summary that relates to repetitive word usage in the first AI-generated content item.

18. The computing apparatus of claim 17, wherein the processor is further configured to generate a second spreadsheet that includes a similarity score of the first AI-generated content item with respect to each of the plurality of historical content items, an edit level of the first AI-generated content item that includes one from among a low edit level, a medium edit level, and a high edit level, and a similarity ranking of the first AI-generated content item with respect to each of the plurality of historical content items.

19. A non-transitory computer readable storage medium storing instructions for detecting and mitigating an artificial intelligence (AI)-generated hallucination, the storage medium comprising executable code which, when executed by a processor, causes the processor to:
receive a first AI-generated content item that has been generated by a large language model (LLM);
retrieve a plurality of historical content items that have been generated by human beings;
compare the first AI-generated content item with the plurality of historical content items in order to determine whether a first text string included within the first AI-generated content item matches with a text string included in at least one from among the plurality of historical content items;
when a determination is made that no match exists, perform a semantic matching operation to identify at least one text string included in the plurality of historical content items that is semantically similar to the first text string; and
determine, based on a result of the comparison and a result of the performance of the semantic matching operation, whether the first AI-generated content item is a hallucination.

20. The storage medium of claim 19, wherein when executed by the processor, the executable code is further configured to cause the processor to use a result of the semantic matching operation to generate a semantic similarity score with respect to each of the plurality of historical content items by using cosine similarity and pre-trained robustly optimized Bidirectional Encoder Representations from Transformers approach (roBERTa) embeddings.
